(19) United States
(12) Patent Application Publication
(10) Pub. No.: US 2007/0234830 A1
(43) Pub. Date: Oct. 11, 2007

(54) Engine starter

(75) Inventors: Hitoshi Ono, Kiryu-shi (JP); Tomohiko Ikemori, Kiryu-shi (JP); Shigeyuki Enkaku, Kiryu-shi (JP); Chihiro Horikoshi, Hanyu-shi (JP); Shinya Saito, Kiryu-shi (JP); Shigehiro Kanbe, Maebashi-shi (JP)

Correspondence Address: OLIFF & BERRIDGE, PLC, P.O. BOX 19928, ALEXANDRIA, VA, 22320, US

(73) Assignee: MITSUBA CORPORATION, KIRYU-SHI (JP)

(21) Appl. No.: 11/723,873

(22) Filed: Mar. 22, 2007

(30) Foreign Application Priority Data
Mar. 24, 2006 (JP) 2006-082651

(51) Int. Cl. F02N 15/02

(52) U.S. Cl. 74/7 E; 74/7 C

(57) ABSTRACT

An engine starter includes a unidirectional rotation clutch system with a clutch outer having an outer-diameter side cylinder portion, a clutch inner having an inner-diameter side cylinder portion, long shaft-shaped clutch rollers that are long in a drive shaft direction and are installed in wedge spaces formed between the inner and outer-diameter side cylinder portions, and springs that urge the clutch rollers toward wedge portions, wherein at least one of the inner and outer-diameter side cylinder portions includes a wear preventive portion that prevents wearing of the clutch rollers that have turned so as to be in an inclined posture with respect to the drive shaft.

### CROSS-REFERENCE TO RELATED APPLICATION

This application claims priority from Japanese Patent Application No. 2006-082651, filed Mar. 24, 2006. The entire disclosure of which is incorporated by reference in its entirety.

### BACKGROUND

The present invention relates to an engine starter for starting an engine.

Generally, an engine starter includes a unidirectional rotation clutch system that is constructed so as not to transmit a driving force of a ring gear on an engine side although it transmits a driving force of a motor. The entire starter is provided between a drive shaft that is subjected to the driving force of the motor and a ring gear on an engine side.

There exists a unidirectional rotation clutch system that includes a clutch outer that is joined to the drive shaft side so as to rotate integrally with the clutch outer including an outer-diameter side cylinder portion, a clutch inner that is engaged with the ring gear on the engine side in a manner enabling it to be disengaged with the clutch inner including an inner-diameter side cylinder portion, long shaft-shaped clutch rollers that are long in the drive shaft direction and installed in wedge spaces formed between the inner and outer cylinder portions, and springs that urge the clutch rollers toward the wedge portions (refer to, for example, Japanese Published Examined Utility Model Application No. JP-Y2-59-26107 and Japanese Published Unexamined Utility Model Application No. JP-U-5-42675).

### SUMMARY

The clutch system is constructed so that the clutch rollers move to wedge portions of the wedge spaces formed between the clutch outer and the clutch inner according to a predetermined unidirectional rotation of the clutch outer in response to driving of the motor side. The clutch rollers are also pressed between the inner periphery of the clutch outer and the outer periphery of the clutch inner, whereby the clutch outer and the clutch inner are rotated integrally. Then, from this state, when the engine side turns into an overrun state, the clutch inner slightly bends, and on the other hand, a load is applied to the clutch rollers so as to make these come out from the wedge portions. Thereby, the clutch rollers become free, and the clutch inner idles with respect to the clutch outer and the clutch rollers.

In this conventional clutch system, when the clutch rollers move near the wedge portions due to an overrun state or a great load is applied to the clutch system, as shown in FIG. 5A and FIG. 5B, the posture in which the clutch rollers 19 are parallel to the drive shaft may be lost and the clutch rollers 19 may turn into an inclined posture in which they are closer to the wedge portions 22a side of the wedge spaces 22 formed between the clutch outer 20 and the clutch inner 21.

A possible reason for this is that the large-diameter cylinder portion forming the clutch outer 20 is formed into a cup shape having a cylinder bottom 20a formed on the motor disposed side, and the large-diameter cylinder portion 20b that has been subjected to a rotating force has a higher ring strength on the cylinder bottom 20a side than on the cylinder opening 20c side. If the clutch inner 21 continues idling in the state that the clutch rollers 19 are in the inclined posture, the clutch inner 21 may wear and deform the motor side ends of the clutch rollers 19. As a result, the clutch function of the clutch system deteriorates. This invention solves the above problems, and achieves other various advantages.

In view of these circumstances, the present invention was made to solve the above-described problem and achieve other various advantages, and the present invention of a first exemplary aspect provides an engine starter including a unidirectional rotation clutch system constructed so as not to transmit a driving force of a ring gear on an engine side according to a starting of an engine although the clutch system is constructed to transmit a driving force of a motor, provided between a drive shaft that is subjected to the driving force of the motor and the ring gear. The clutch system includes a clutch outer having an outer-diameter side cylinder portion and a clutch inner having an inner-diameter side cylinder portion, long shaft-shaped clutch rollers that are long in a drive shaft direction and are installed in wedge spaces formed between the inner and outer-diameter side cylinder portions, and springs that urge the clutch rollers toward wedge portions, wherein at least one of the inner and outer-diameter side cylinder portions includes a wear preventive portion that prevents wearing of the clutch rollers that have turned so as to be in an inclined posture with respect to the drive shaft.

The invention of a second exemplary aspect provides the engine starter according to the first exemplary aspect, wherein the wear preventive portion is formed by reducing a bending load of the cylinder portion by forming the cylinder portion into a thin portion.

The invention of a third exemplary aspect provides the engine starter according to the first or second exemplary aspect, wherein the wear preventive portion is formed so as to face either end of the clutch rollers.

The invention of a fourth exemplary aspect provides the engine starter according to the second or third exemplary aspect, wherein the thin portion is formed into an inclined shape so as to become gradually thinner.

The invention of a fifth exemplary aspect provides the engine starter according to any one of the first through fourth exemplary aspects, wherein the wear preventive portion is formed on the clutch inner.

According to the invention of the first exemplary aspect, an engine starter is provided which has excellent durability by preventing local wearing of the clutch rollers.

According to the invention of the second exemplary aspect, a wear preventive portion can be formed without providing a special member.

According to the inventions of the third and fourth exemplary aspects, wearing prevention by means of the clutch inner can be reasonably realized.

According to the invention of the fifth exemplary aspect, the construction for preventing wearing can be further simplified.

### BRIEF DESCRIPTION OF THE DRAWINGS

Various exemplary embodiments will be described with reference to the drawings, wherein:

FIG. 1 is a partially sectional side view of an engine starter;

FIG. 2 is a sectional front view of a clutch system;

FIG. 3A and FIG. 3B are sectional front views of a main portion for describing how the clutch system operates;

FIG. 4A is an enlarged sectional view obtained by partially cutting FIG. 1, and

FIG. 4B is an enlarged sectional view of a main portion in the second embodiment; and

FIG. 5A is a perspective view describing a state that the clutch rollers are in the inclined posture in a conventional example and FIG. 5B is an enlarged sectional front view describing a state that the clutch rollers are in the inclined posture in a conventional example.

### DETAILED DESCRIPTION OF EMBODIMENTS

Next, an embodiment of the present invention will be described with reference to the drawings.

In the drawings, the reference numeral 1 denotes an engine starter for starting an engine installed in a vehicle or the like, and a motor (electric motor) M including the engine starter 1 uses a brush-type DC motor. A base end of a motor shaft 2 is pivotally supported in a rotatable manner on an end cover 3a that closes the base end side opening of a cylindrical yoke 3, and on the other hand, onto the tip end of the motor shaft 2, a commutator 4 is integrally fit. To the outer periphery of the commutator 4, a ring-shaped holder stay 5 is incorporated so as to fit thereon, and the holder stay 5 is set so as to be incorporated in the tip end side opening of the yoke 3.

The reference numeral 6 denotes a bottomed cylindrical case, and this case 6 forms a reduction gear D that is disposed adjacent to the tip end side of the motor M, that is, adjacent to the holder stay 5. In the case 6, the tip end 2a of the motor shaft 2 is installed. Furthermore, in the case 6, the base end of the drive shaft 7 is disposed so as to fit onto the motor shaft tip end 2a in a relatively rotatable manner. A plurality of planet gears 8 are arranged concentrically with the motor shaft tip end 2a and engage with the motor shaft tip end 2a and rotate circumferentially inside the case 6 according to the rotation of the motor shaft 2. In addition, a ring-shaped support plate 9 is integrated with the planet gears 8 via a support shaft 9a. By fitting the inner peripheral surface of the support plate 9 integrally on the drive shaft 7, the circumferential rotation of the planet gears 8 is interlocked with and joined to the drive shaft 7. Thereby, the driving force of the motor M is transmitted to the drive shaft 7 in a speed reduced state.

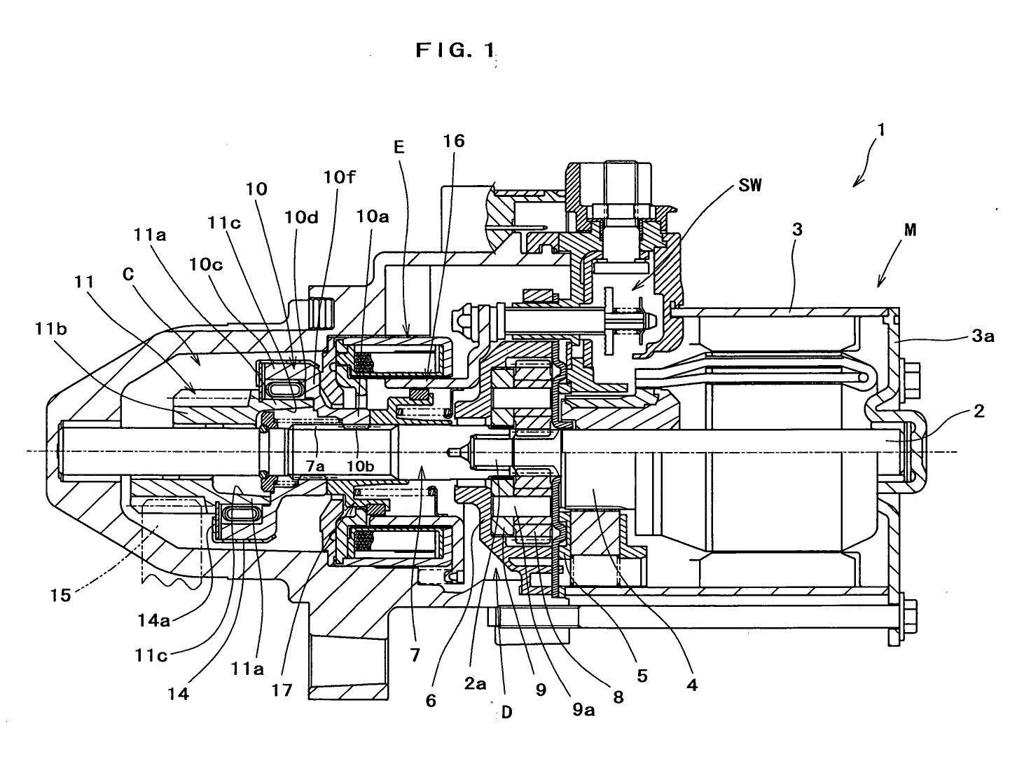

On the tip end of the drive shaft 7, a unidirectional rotation clutch system C is disposed. A clutch outer 10 formed of a stepped cylinder is incorporated so as to fit onto the drive shaft 7 in a state such that a helical spline 10b formed on the inner peripheral surface of a small-diameter cylinder portion 10a is engaged with a helical spline 7a engraved in the outer peripheral surface of the tip end of the drive shaft 7. Then, when relative rotation in a predetermined rotating direction occurs between the drive shaft 7 and the clutch outer 10, the clutch outer 10 is set so as to rotatively move along the helical spline 7a of the drive shaft 7. Thereby, the clutch outer 10 moves between an inactive position (the position shown in the upper half of FIG. 1) on the base end side of the drive shaft 7 and an acting position on the tip end side.

Furthermore, on the tip end side of the clutch outer 10, a large-diameter cylinder portion 10c corresponding to the outer-diameter side cylinder portion of the present invention is formed. On the inner peripheral surface of the large-diameter cylinder portion 10c, a plurality (five in this embodiment) of concave portions 10d concaved in the outer diameter direction is formed circumferentially. These concave portions 10d are set so as to form a plurality of wedge spaces S between the concave portions 10d and the outer peripheral surface of a small-diameter cylinder portion (corresponding to the inner-diameter side cylinder portion of the present invention) 11a by fitting the small diameter cylinder portion 11a formed on the base end of the clutch inner 11 to the inner side of the large-diameter cylinder portion 10c.

The clutch inner 11 has a ring-shaped pinion gear 11b integrally formed on the tip end side of the small-diameter cylinder portion 11a on the base end side, and this pinion gear 11b is set so as to project toward the tip end side from the clutch outer 10.

Herein, the clutch inner 11 is formed so as to freely fit onto the drive shaft 7, and thereby, the clutch inner 11 is set in a relatively rotatable manner with respect to the drive shaft 7.

On the other hand, each wedge space S has a wedge portion 10e, whose length in the diameter direction becomes gradually shorter, is formed on one end in the circumferential direction. However, the other end in the circumferential direction is formed to have a constant length in the diameter direction. In one side space in the circumferential direction of each wedge space S, a columnar clutch roller 12 long in the axial direction of the drive shaft 7 is installed, and on the other side space in the circumferential direction, a spring 13 for urging the clutch roller 12 toward the wedge portion 10e side is installed.

The reference numeral 14 denotes a cylindrical clutch case disposed on the outer periphery of the clutch outer large-diameter cylinder portion 10c. To the opening end of the tip end side of the clutch case 14, a cover ring 14a is fixed from the large-diameter cylinder portion 10c to the clutch inner 11 so that the clutch outer 10 and the clutch inner 11 become relatively rotatable or integrally rotatable in the circumferential direction while they are movable integrally in the axial direction.

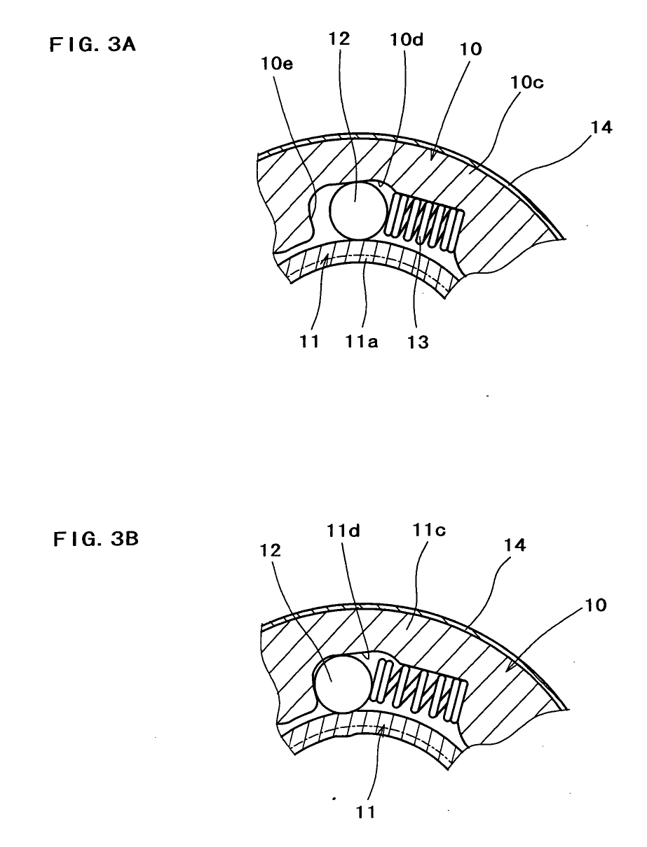

When the drive shaft 7 is in a driving stop state, the clutch system C thus constructed is positioned at an inactive position of the base end side (motor M disposed side) and the clutch rollers 12 installed in the wedge spaces S are positioned closer to the other sides in the circumferential direction than the wedge portions 10e as shown in FIG. 3A, and power is not transmitted between the clutch outer 10 and the clutch inner 11.

When the drive shaft 7 rotates from the stop state and relative rotation occurs with respect to the clutch outer small-diameter cylinder portion 10a as described above, the clutch outer 10 is positioned at the acting position along the helical spline 7a of the drive shaft 7. However, according to positioning of the clutch system C at the acting position, the pinion gear 11b disposed on the tip end of the clutch inner 11 reaches the disposed position of the ring gear 15 on the engine side.

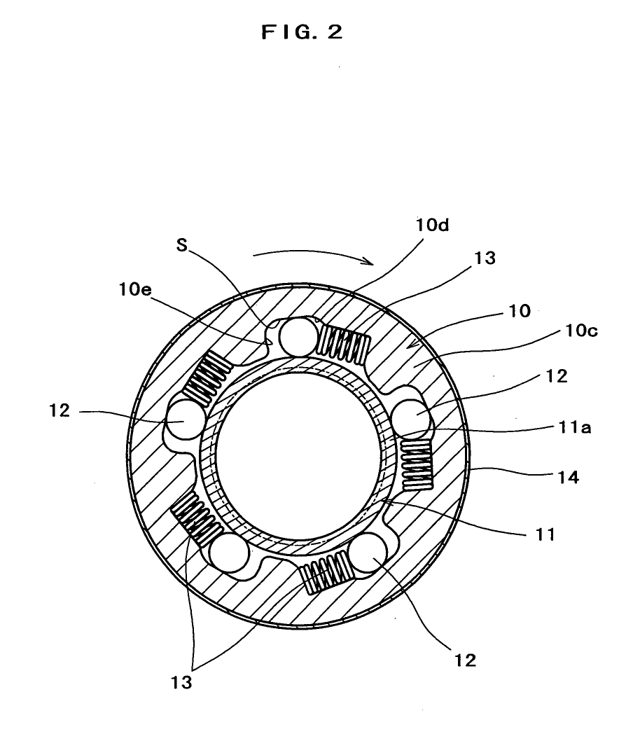

On the other hand, when the drive shaft 7 rotates in a predetermined direction (the arrow direction in FIG. 2), as shown in FIG. 3B, the clutch rollers 12 that have been subjected to the urging force of the springs 13 are pressed into the wedge portions 10e of the wedge spaces S. In this state, the clutch outer 10 and the clutch inner 11 are integrated and the power from the clutch outer 10 is transmitted to the clutch inner 11 and they are rotated integrally. Thereby, the pinion gear 11b of the clutch system C positioned at the acting position engages with the ring gear 15 and forcibly rotates it.

Furthermore, from the above-described state, when the engine starts and the number of rotations of the ring gear 15 exceeds the number of rotations of the clutch outer 10, the clutch inner 11 that is rotating integrally with the ring gear 15 by engaging with it bends. On the other hand, a load acts on the clutch rollers 12 so as to make the clutch rollers 12 come out from the wedge portions 10e. Thereby the clutch system turns into an overrun state where the clutch inner 11 relatively rotates (idles) with respect to the clutch outer 10 that are rotating integrally with the drive shaft 7. That is, a state is created where power transmission from the clutch inner 11 to the clutch outer 10 is cut off.

On the other hand, the large-diameter cylinder portion 10c positioned on the tip end side of the clutch outer 10 is formed into a cup shape which uses, as a cylinder bottom 10f, a step portion between the cylinder bottom 10f and the small-diameter cylinder portion 10b positioned on the motor M disposed side on the base end side. The cylinder portion 10c has an opening 10g formed on the tip end side, and the motor M disposed side has a ring strength higher than that of the opening 10g side. Therefore, as described above, when the clutch rollers 12 move in the vicinity of the wedge portions 10e where the clutch rollers 12 move to come out from the pressed state against the wedge portions 10e of the wedge spaces S formed by the inner peripheral surface of the clutch outer 10 and the outer peripheral surface of the clutch inner 11, due to the high ring strength of the motor M disposed side of the clutch outer 10, the loads for coming-out of the motor M disposed sides of the clutch rollers 12 from the wedge portions 10e are great. As a result, the motor M disposed portions of the clutch rollers 12 deflect to one side of the circumferential direction, and may turn into an inclined posture inclined with respect to the drive shaft 7.

Then, in this construction, the inner peripheral surface of the small-diameter cylinder portion 11a of the clutch inner 11 is formed into an inclined surface 11c displaced to the outer diameter side as it comes closer to the motor M disposed side on the base end side. The thickness of the clutch inner 11 becomes thinner toward the motor M disposed side, the ring strength of the clutch inner 11 becomes lower toward the motor M disposed side, the portion becomes smaller in bending load and becomes easy to bend, and the construction corresponds to an example of a wear preventive portion of the present invention.

With this construction, when the clutch inner 11 of the clutch system C overruns, the clutch rollers 12 turn into the inclined posture in the wedge portions 10e. In this state, even if the clutch inner 11 idles, the wear preventive portion is formed by the inclined surface 11c that becomes thinner toward the motor M disposed side and makes the clutch inner 11 easy to bend. As a result, the clutch inner 11 bends due to contact with the clutch rollers 12 and prevents local wearing of the motor M disposed portions of the clutch rollers 12. Thereby, the clutch rollers 12 are prevented from being deformed and deteriorating the functions of the clutch system C.

In FIG. 1, the reference letter E denotes an electromagnetic controller that is supplied with power and excited based on turning-ON an ignition switch that is not shown. The reference letters SW denote a switch for supplying power to the motor M according to excitation of the electromagnetic controller E. The reference numerals 16 and 17 denote first and second urging units that urge switching of the SW, that is, urge the clutch system C to be displaced toward the acting position side.

In this embodiment constructed as described above, in the engine starter 1, according to turning-ON of the ignition switch that is not shown, the drive shaft 7 is driven to rotate as predetermined, and the clutch system C is displaced to the acting position. As a result, the pinion gear 11b provided at the tip end of the clutch inner 11 engages with the ring gear 15, and on the other hand, the clutch outer 10 and the clutch inner 11 rotate integrally to start rotating the ring gear 15 and start the engine. In this construction, when the number of rotations of the ring gear 15 exceeds that of the clutch outer 10 and the clutch inner 11 idles, even when the motor M disposed sides of the clutch rollers 12 turn into the inclined posture in which they are displaced to the wedge portions 10e sides of the wedge spaces S due to the shape of the clutch outer 10, a wear preventive portion is formed by the inclined surface 11c which becomes thinner toward the motor M disposed side formed on the clutch inner 11. The clutch inner 11 thus comes into contact with the clutch rollers 12 in the inclined posture and bends. Wearing of the clutch rollers 12 can thus be reduced. Thereby, local wearing of the motor M disposed side portions of the clutch rollers 12 of the conventional construction can be prevented. As a result, the problem such that the clutch rollers 12 are deformed and deteriorate the functions of the clutch system C can be eliminated, and an engine starter with excellent durability can be provided.

In addition, in this construction, in the state where the clutch rollers 12 are pressed into the wedge portions 10e on the motor M disposed side, due to the high ring strength of the clutch outer 10, a lower ring strength is opposed by the inclined surface 11c of the clutch inner 11. The load to be applied in the axial length direction of the clutch rollers 12 is thus prevented from greatly acting on the motor M disposed side. In addition, the load for making the clutch rollers 12 come out from the state that they are pressed into the wedge portions 10e becomes uniform. Therefore, the inclined posture of the clutch rollers 12 can also be prevented.

Furthermore, in the embodiment of the present invention, the wear preventive portion is constructed by forming the inner peripheral surface of the cylindrical clutch inner 11 into the thin inclined surface 11c, so that the wear preventive portion can be formed without providing a special component.

In this construction, the inclined surface 11c is formed so as to become thinner toward the motor M disposed side at which the clutch rollers 12 are subjected to a high ring strength, so that forming of the clutch inner 11 can be easily performed, and the clutch inner 11 can be naturally bended.

In this construction, the wear preventive portion is provided not on the clutch outer 10 but on the clutch inner 11 side and is formed on the inner peripheral surface that freely fits with the drive shaft 7, so that the construction of the wear preventive portion can be further simplified.

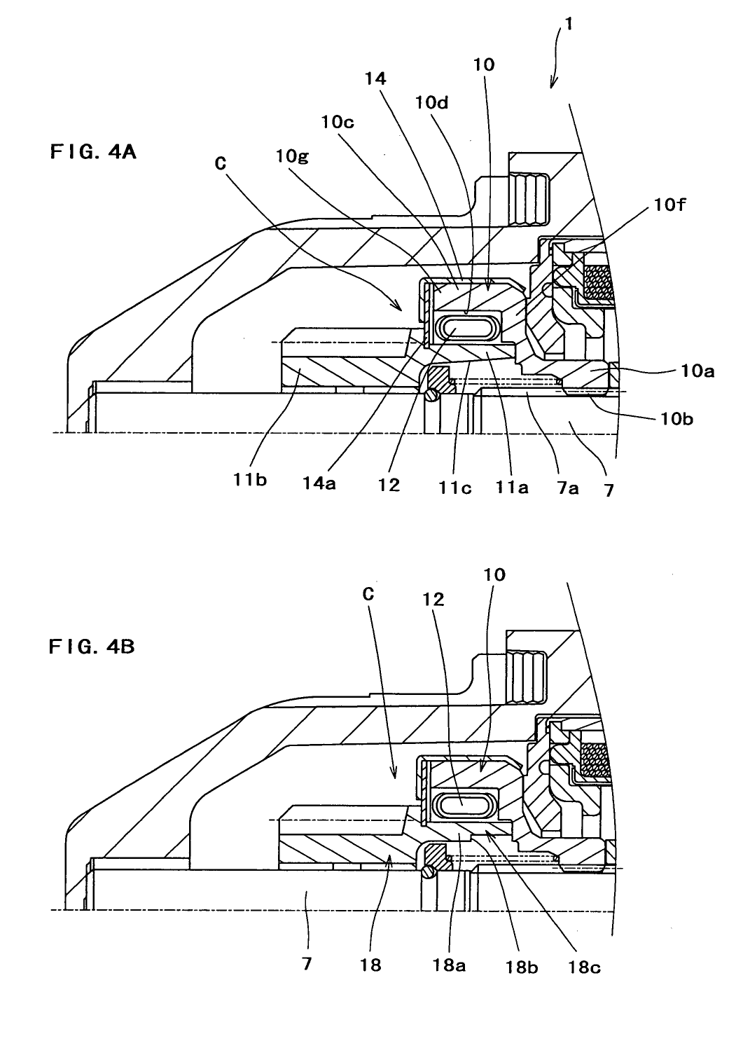

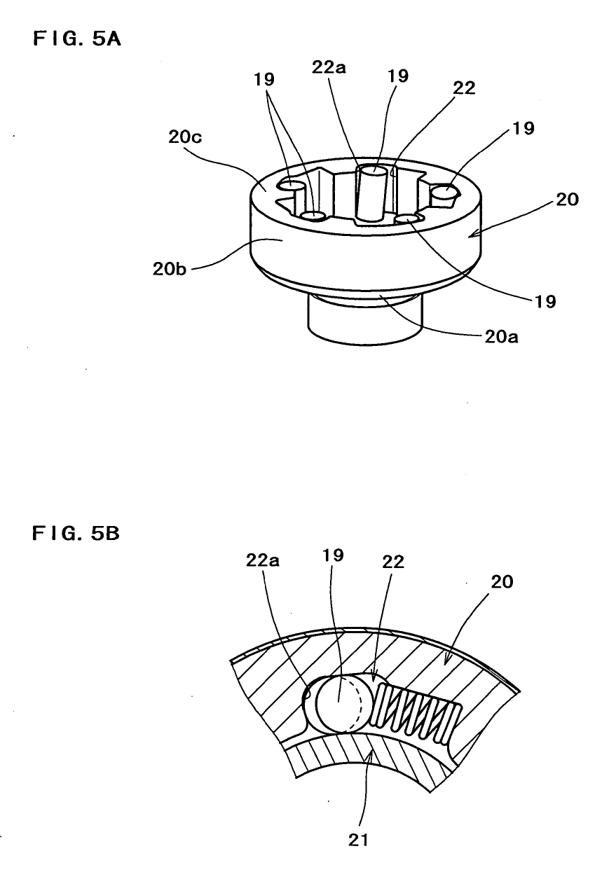

As a matter of course, the present invention is not limited to the above-described embodiment, and can also be carried out in the second embodiment shown in FIG. 4B. The basic construction of this second embodiment is the same as the first embodiment, so that description of members will be omitted by attaching the same reference numerals and letters to the same members as in the first embodiment.

In this embodiment, a step portion 18b is provided on the inner peripheral surface of the small-diameter cylinder portion 18a of the clutch inner 18, and only the half portion 18c of the motor disposed side is formed to be thin, whereby a wear preventive portion is formed. With this construction, even when the clutch inner 18 idles in a state that the clutch rollers 12 are in the inclined posture, wearing of the clutch rollers 12 can be eliminated by bending the half portion 18c of the motor disposed side of the clutch inner 18, and the clutch rollers 12 can be prevented from being deformed.

What is claimed is:

1. An engine starter, comprising:
a unidirectional rotation clutch system constructed so as not to transmit a driving force of a ring gear on an engine side according to a starting of an engine although the clutch system is constructed to transmit a driving force of a motor, provided between a drive shaft that is subjected to the driving force of the motor and the ring gear, wherein the clutch system comprises:
a clutch outer having an outer-diameter side cylinder portion,
a clutch inner having an inner-diameter side cylinder portion,
long shaft-shaped clutch rollers that are long in a drive shaft direction and are installed in wedge spaces formed between the inner and outer-diameter side cylinder portions, and
springs that urge the clutch rollers toward wedge portions, wherein at least one of the inner and outer-diameter side cylinder portions includes a wear preventive portion that prevents wearing of the clutch rollers that have turned so as to be in an inclined posture with respect to the drive shaft.

2. The engine starter according to claim 1, wherein the wear preventive portion is formed by reducing a bending load of one of the inner and outer-diameter side cylinder portion by forming the one of the inner and outer-diameter side cylinder portion into a thin portion.

3. The engine starter according to claim 1, wherein the wear preventive portion is formed so as to face either end of the clutch rollers.

4. The engine starter according to claim 2, wherein the thin portion is formed into an inclined shape so as to become gradually thinner.

5. The engine starter according to claim 1, wherein the wear preventive portion is formed on the clutch inner.

6. The engine starter according to claim 2, wherein the wear preventive portion is formed so as to face either end of the clutch rollers.

7. The engine starter according to claim 3, wherein the wear preventive portion includes a thin portion that is formed into an inclined shape so as to become gradually thinner.

8. The engine starter according to claim 6, wherein the thin portion is formed into an inclined shape so as to become gradually thinner.

9. The engine starter according to claim 2, wherein the wear preventive portion is formed on the clutch inner.

10. The engine starter according to claim 3, wherein the wear preventive portion is formed on the clutch inner.

11. The engine starter according to claim 4, wherein the wear preventive portion is formed on the clutch inner.

12. The engine starter according to claim 6, wherein the wear preventive portion is formed on the clutch inner.

13. The engine starter according to claim 7, wherein the wear preventive portion is formed on the clutch inner.

14. The engine starter according to claim 8, wherein the wear preventive portion is formed on the clutch inner.

15. The engine starter according to claim 2, wherein the thin portion is formed into an inclined shape so as to become gradually thinner toward the motor.

16. The engine starter according to claim 1, wherein the wear preventive portion is structured such that a strength of one of the inner and outer-diameter side cylinder portion is lower toward the motor.

17. The engine starter according to claim 1, wherein the wear preventive portion includes a step portion.

18. The engine starter according to claim 2, wherein the thin portion is formed into a stepped shape.
